(19) United States
(12) Patent Application Publication
(10) Pub. No.: US 2012/0319011 A1
(43) Pub. Date: Dec. 20, 2012

(54) MERCURY UV LAMP WITH IMPROVED ACTINIC SPECTRUM

(76) Inventors: Dale E. Brabham, (US); Holger Claus, (US); Philip Snapp, (US)

(21) Appl. No.: 13/525,533

(22) Filed: Jun. 18, 2012

Related U.S. Application Data
(60) Provisional application No. 61/498,926, filed on Jun. 20, 2011.

(51) Int. Cl. C02F 1/32; H01J 61/44

(52) U.S. Cl. 250/492.1; 313/486

(57) ABSTRACT

A low-pressure mercury or amalgam lamp with praseodymium (Pr) doped particles of lanthanum phosphate converts 185 nm radiation to UV-C (186 nm-280 nm). For water purification, a plurality of low-pressure mercury or amalgam lamps with phosphor that convert 185 nm radiation to UV-C (186 nm-280 nm) may be used. A method for photolysis of nitroso dimethyl amine (NDMA) may include passing electrical current through a low pressure mercury or amalgam lamp, radiating 254 nm radiation through the lamp envelope into water containing the NDMA, converting 185 nm radiation within the lamp into 230 nm-240 nm radiation within the lamp via a phosphor within the lamp, and radiating the 230-240 nm radiation through the lamp envelope and into the water containing the NDMA, with the radiation from the lamp photolysizing the NDMA.

### PRIORITY CLAIM

This application claims priority to U.S. Provisional Patent Application No. 61/498,926 filed Jun. 20, 2011 and incorporated herein by reference.

### BACKGROUND OF THE INVENTION

Both low pressure mercury lamps (LPML) and mercury amalgam lamps (AL) are used for water disinfection and water treatment. Both can be produced in ozone-free versions which eliminate the 185 nm radiation and prevent formation of ozone. Both types can be made in 185 nm transmitting quartz for applications where the 185 nm radiation or the ozone produced by this radiation is useful, although this action is limited because the 185 nm radiation can penetrate neither air nor water any significant distance.

The low pressure mercury lamp (LPML) is extremely efficient in converting electrical energy into useful radiation. At 254 nm the conversion is about 35 percent. At 185 nm the conversion is 10-15 percent. These conversion percentages refer to externally useful radiation compared to input power. The internal conversion is higher since some losses occur at the discharge envelope. In the low pressure amalgam mercury lamp (AL), the mercury pressure is reduced and controlled by mixing with another metal, commonly indium. The amalgamated mercury allows the lamp to operate at higher temperatures and therefore higher wattages while maintaining the desired optimum mercury pressure.

Fluorescent lamps convert the 254 nm to visible wavelengths (400-800 nm). Phosphors absorb the 254 nm radiation and re-emit the light at the higher wavelengths. This follows the normal Stokes shift where luminescent material emits at longer wavelength than the absorption (initiating) wavelengths.

U.S. Pat. No. 7,396,491 B2 and U.S. Pat. No. 7,808,170 B2 describe dielectric barrier lamps with phosphor coating to convert the 172 nm Xe-excimer radiation to light into wavelengths better optimized for water treatment. A primary candidate material for the phosphor coating is a praseodymium (Pr) doped particles of lanthanum phosphate, LaP04.

The Pr containing phosphors have been extensively studied because under special conditions the Pr centers in the phosphor can convert one UV photon into two visible photons. This doubling effect has generated intense interest. However, the wavelengths produced by these types of phosphors are not especially useful for water treatment. A practical product has not been achieved using the doubling effect. Nonetheless, an extensive literature on Pr phosphors has been published.

A recent patent application, WO 2009/077350 A1, updates the status of methodology for producing the luminescent rare-earth powders. The quantum efficiency to convert the mercury radiation to useful light is highly dependent on particle size, so that, the art is related to the control of particle size in milling the powders and applying them to the inner surface of glass tubes. However, WO 2009/077350 A1 focuses entirely on fluorescent lamps that produce visible radiation.

### SUMMARY OF THE INVENTION

A low-pressure mercury or amalgam lamp with praseodymium (Pr) doped particles of lanthanum phosphate converts 185 nm radiation to UV-C (186 nm-280 nm). For water purification, a plurality of low-pressure mercury or amalgam lamps with phosphor that convert 185 nm radiation to UV-C (186 nm-280 nm) may be used. A method for photolysis of nitroso dimethyl amine (NDMA) may include passing electrical current through a low pressure mercury or amalgam lamp, radiating 254 nm radiation through the lamp envelope into water containing the NDMA, converting 185 nm radiation within the lamp into 230 nm-240 nm radiation within the lamp via a phosphor within the lamp, and radiating the 230-240 nm radiation through the lamp envelope and into the water containing the NDMA, with the radiation from the lamp photolysizing the NDMA.

### DETAILED DESCRIPTION

Some of the 245 nm radiation is transformed to wavelengths between 185 and 254 nm, where penetration of air and water are possible, in applications where the shorter wavelengths have an advantage over the 254 nm radiation. One application is direct photolysis of nitroso dimethyl amine (NDMA), a known carcinogen that is showing up in water supplies. Photolysis of the NDMA has been shown to be an effective and safe way to remove it from low turbidity waste water. The radiation at 254 nm has a reduced efficacy for this photolysis because NDMA absorbs less at this wavelength than at the peak absorption 235 nm, and the radiation at 185 nm does not penetrate into the water sufficiently to produce an effect. Conversion of radiation to a band between 230 and 240 nm is therefore advantageous.

In one lamp design, a phosphor is used to absorb the 185 nm light and re-emit it in the desired band, especially in the 230-240 nm band. In a UV lamp for water treatment, UV luminescent phosphor is applied to the walls of a low pressure mercury or amalgam type discharge lamp. The coating absorbs the 185 nm radiation from the mercury and re-emits it at longer wavelengths. This reduces the problem of absorption of the shorter (185 nm) wavelength radiation by oxygen and water by converting it to longer wavelengths 186-253 nm. In addition to this radiation, which is useful for photolyzing smaller organic molecules, the mercury 254 nm radiation, provides substantial germicidal action.

In an alternative design, a low-pressure mercury or amalgam lamp with phosphor converts 185 nm radiation to UV-C (186 nm-280 nm). In another design, a low-pressure mercury or amalgam lamp with phosphor includes a luminescent rare-earth powder that converts 185 nm radiation to UV-C (186 nm-280 nm).

Modifications and substitutions may of course be made without departing from the spirit and scope of the invention. The invention therefore should not be limited except to the following claims and their equivalents. The specific wavelengths discussed are intended to also include the surrounding higher and lower wavelengths, as will be known to those skilled in the art.

1. A low-pressure mercury or amalgam lamp with praseodymium (Pr) doped particles of lanthanum phosphate that converts 185 nm radiation to UV-C (186 nm-280 nm).

2. A water purification apparatus comprising a plurality of low-pressure mercury or amalgam lamps with phosphor that convert 185 nm radiation to UV-C (186 nm-280 nm).

3. The apparatus of claim 2 wherein the lamps convert 185 nm radiation to UV-C (186 nm-280 nm) with praseodymium (Pr) doped particles of lanthanum phosphate.

4. A method for photolysis of nitroso dimethyl amine (NDMA), comprising:
passing electrical current through a low pressure mercury or amalgam lamp;
radiating 254 nm radiation through the lamp envelope into water containing the NDMA;
converting 185 nm radiation within the lamp into 230 nm-240 nm radiation within the lamp via a phosphor within the lamp; and
radiating the 230-240 nm radiation through the lamp envelope and into the water containing the NDMA, with the radiation from the lamp photolysizing the NDMA.
